(19) United States
(12) Patent Application Publication
(10) Pub. No.: US 2024/0394114 A1
(43) Pub. Date: Nov. 28, 2024

(54) SERVICE COMBINATION DEVICE AND SERVICE COMBINATION METHOD

(71) Applicants: Digiwin Software Co., Ltd, Shanghai (CN); DATA SYSTEMS CONSULTING CO., LTD., New Taipei City (TW)

(72) Inventors: Xiaoliang Ma, Shanghai (CN); Guoxin Sun, Shanghai (CN)

(73) Assignees: Digiwin Software Co., Ltd, Shanghai (CN); DATA SYSTEMS CONSULTING CO., LTD., New Taipei City (TW)

(21) Appl. No.: 18/664,262

(22) Filed: May 14, 2024

(30) Foreign Application Priority Data
May 24, 2023 (CN) 202310591191.2

(51) Int. Cl. G06F 9/50

(52) U.S. Cl. CPC G06F 9/5061

(57) ABSTRACT

A service combination device and a service combination method are provided. The service combination device includes a storage device and a processor. The storage device is configured to store a service combination module, a graph storage module, and a combination optimization module. The processor is coupled to the storage device and configured to receive initial data. The processor executes the service combination module to generate a plurality of target data according to the initial data. The processor executes the graph storage module to search a data graph according to the target data to obtain a plurality of service data combinations. The processor executes the combination optimization module to filter out an optimized service data combination from the plurality of service data combinations. The service combination device and service combination method of the disclosure are adapted to automatically perform combination and optimization of service data.

### CROSS-REFERENCE TO RELATED APPLICATION

This application claims the priority benefit of China application serial no. 202310591191.2, filed on May 24, 2023. The entirety of the above-mentioned patent application is hereby incorporated by reference herein and made a part of this specification.

### BACKGROUND

### Technical Field

The disclosure relates to a data processing technology, and particularly relates to a service combination device and a service combination method.

### Description of Related Art

A conventional service combination process is difficult and ineffective in actual use due to excessive formal representations and inconsistent data structures. Therefore, the conventional service combination processing has problems of high difficulty in use and a poor automatic optimization function.

### SUMMARY

The disclosure is directed to a service combination device and a service combination method, which are adapted to automatically perform service combination and packaging according to initial data.

An embodiment of the disclosure provides a service combination device including a storage device and a processor. The storage device is configured to store a service combination module, a graph storage module, and a combination optimization module. The processor is coupled to the storage device and configured to receive initial data. The processor executes the service combination module to generate a plurality of target data according to the initial data. The processor executes the graph storage module to search a data graph according to the target data to obtain a plurality of service data combinations. The processor executes the combination optimization module to filter out an optimized service data combination from the plurality of service data combinations. The service combination device and service combination method of the disclosure are adapted to automatically perform combination and package of service data.

An embodiment of the disclosure provides a service combination method including following step: generating a plurality of target data through a service combination module according to initial data; searching a data graph by a graph storage module according to the plurality of target data, so as to obtain a plurality of service data combinations; and filtering out an optimized service data combination from the plurality of service data combinations by a combination optimization module.

Based on the above description, the service combination device and service combination method of the disclosure are adapted to automatically obtain the corresponding service data combination according to the initial data and the data graph.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic circuit diagram of a service combination device according to an embodiment of the disclosure.

FIG. 2 is a flowchart of a service combination method according to an embodiment of the disclosure.

FIG. 3 is a schematic diagram of a service combination device according to an embodiment of the disclosure.

FIG. 4 is a schematic diagram of a client device and a server according to an embodiment of the disclosure.

FIG. 5 is a schematic diagram of a data graph according to an exemplary embodiment of the disclosure.

### DESCRIPTION OF THE EMBODIMENTS

Reference will now be made in detail to the present preferred embodiments of the disclosure, examples of which are illustrated in the accompanying drawings. Wherever possible, the same reference numbers are used in the drawings and the description to refer to the same or like parts.

Firstly, a service combination device and a service combination method of the disclosure may efficiently combine service combinations to be executed, and at the same time solve adaptation between different types of input data and output data. Initial data described in the various embodiments of present disclosure may be, for example, a service for calculating project cost information, a service for generating material information in manufacturing, a service for calculating labor cost information, etc. The data related to calling services may all be defined as the initial data, and include service content such as application programming interface (API) address, service type, data state, characteristics, etc. Moreover, there will be a series of corresponding processing logics for different types of initial data in different states, so the disclosure may encapsulate these logics as services. When combining services (i.e., data related to calling services), it is only necessary to define the services to be combined (such as specific data calling service, cost project calculation service, etc.) and data descriptions that may be obtained from sources or contexts (i.e., currently available data), the service combination device of the disclosure may automatically recommend an appropriate service combination (i.e., a plurality of service data). In this way, it may realize a map retrieval method of service input and output and realize directional and rapid combination of multiple services (i.e., calling API services), thereby greatly simplifying the process of generating service combinations in enterprise-level complex business situations.

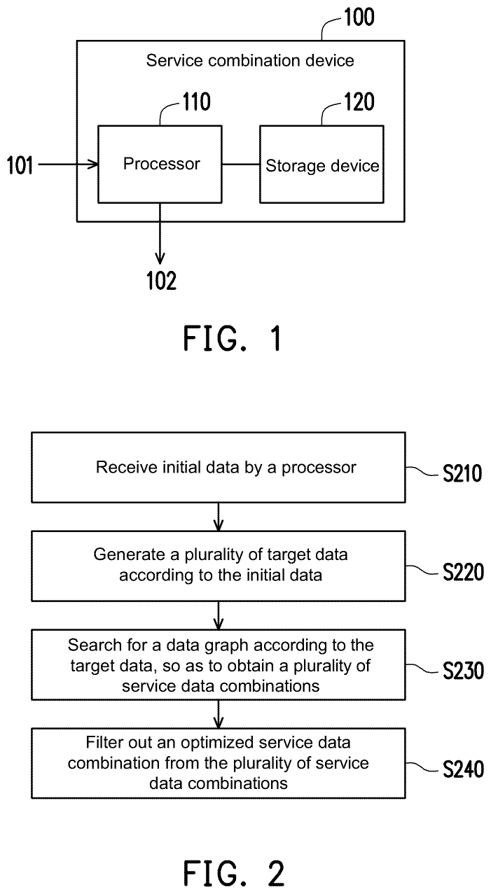

FIG. 1 is a schematic circuit diagram of a service combination device according to an embodiment of the disclosure. Referring to FIG. 1, a service combination device 100 includes a processor 110 and a storage device 120. The processor 110 is coupled to the storage device 120. The service combination device 100 may also include an input device with actual circuit components, a user interface, a communication interface, or a data transmission interface, etc., so that the processor 110 may receive instructions or signals matching requests from data sources or external devices or according to user operations. In the embodiment, the service combination device 100 may be, for example, a personal computer, a workstation computer, or other electronic devices with data computing capabilities. In an embodiment, the service combination device 100 may also be integrated in a cloud server or a private server inside an enterprise. In an embodiment, the service combination device 100 may be used, for example, to implement an enterprise resource planning (ERP) system or a software as a service (SAAS) system, and may execute a plurality of application programming interfaces (APIs) to obtain a service combination that must be called based on current data (such as a project number, a project scale, etc.) and demand data (such as project cost).

In the embodiment, the processor 110 of the service combination device 100 may include, for example, a central processing unit (CPU), or other programmable general purpose or special purpose microprocessor, digital signal processor (DSP), application specific integrated circuits (ASIC), programmable logic device (PLD), other similar processing circuits or a combination of these devices.

In the embodiment, the storage device 120 may implement a remote cloud storage service or a local data storage service. The storage device 120 may include a memory and/or a database, where the memory may be, for example, a non-volatile memory (NVM). The storage device 120 may store related programs, modules, systems, or algorithms for implementing various embodiments of the disclosure, so as to be accessed and executed by the processor 110 to realize relevant functions and operations described in the various embodiments of the disclosure. The storage device 120 may also be used, for example, to cache structured and packaged data and service combinations described in the various embodiments of the disclosure.

FIG. 2 is a flowchart of a service combination method according to an embodiment of the disclosure. Referring to FIG. 1 and FIG. 2, the service combination device 100 may perform following steps S210-S240. In step S210, the processor 110 may receive initial data 101. In the embodiment, the processor 110 of the service combination device 100 may receive the initial data 101 from a data source. In this regard, the data source may be, for example, raw business data or data obtained through an application programming interface. Alternatively, the initial data 101 may be data generated by certain sensors and specific data processing, environmental information, or artificial settings, etc. For example, the initial data 101 may be a specific service to be called and current data. In one embodiment, a user may input the initial data 101 into the processor 110 by operating a service combination operation interface.

In step S220, the processor 110 executes a service combination module to generate a plurality of target data according to the initial data 101. In the embodiment, the processor 110 splits the initial data 101 into the plurality of target data. In an embodiment, the initial data 101 is a target service to be called (for example, project cost calculation service), and the plurality of target data corresponding to the initial data 101 is the data required for calling the target service (for example, project purchase information and staff cost information). In another embodiment, the initial data 101 is a description of the target data that needs to be obtained (for example, project cost, total expenditure value, cost per unit project), and the target data may be subdivided data of the initial data (for example, project A cost and project B cost, staff cost data, equipment cost data). The initial data 101 and the target data refer to that certain transactions in the real world may be mapped into a digital domain for encapsulating into data. In the embodiment, the initial data 101 and the target data may include at least one of a data field and a data object. Moreover, the data field include a data type, a data feature related attribute (the field is described and implemented by a language of a corresponding coding program). The data object includes a data type, a data field list, a primary key, and other attributes. In the embodiment, the initial data 101 and the target data may also include other information recorded with raw environment data (such as a current staff number, a current project number, and current inventory data, etc.).

In step S230, the processor 110 searches for a data graph according to the plurality of target data, and obtains a plurality of service data combinations. In the embodiment, the service data combination refers to an algorithm or logic (i.e., a usage order and directionality of multiple services) of combining multiple service data (i.e., data that calls API services, including API addresses and input data), and the service data may define a range of data that may be processed by itself (for example, the input data corresponding to the service (i.e., API) for calculating labor cost is labor cost data). In step S240, the processor 110 filters out an optimized service data combination from the plurality of service data combinations. Specifically, the processor 110 selects an optimized service data combination 102 from the plurality of service data combinations according to the user's default settings (for example, the shortest path, the fastest calculation path). In this way, the user only needs to input the data to be obtained or the service to be called, and the service combination device 100 may automatically generate the service combination to be executed according to the current data to the service to be called (i.e., the initial data 101).

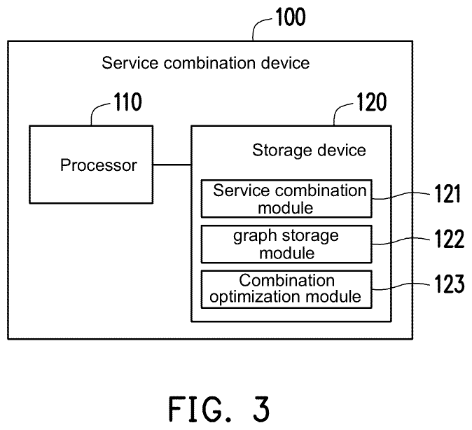

FIG. 3 is a schematic diagram of a service combination device according to an embodiment of the disclosure. Referring to FIG. 1 and FIG. 3, in the embodiment, the storage device 120 may store a service combination module 121, a graph storage module 122 and a combination optimization module 123. In an embodiment, the graph storage module is a database, and the plurality of service data combinations include service directionality parameters. The data graph includes a plurality of service data, a plurality of input data, and a plurality of output data. Specifically, the data graph also includes a connection relationship and a mapping relationship among the plurality of service data, the plurality of input data, and the plurality of output data.

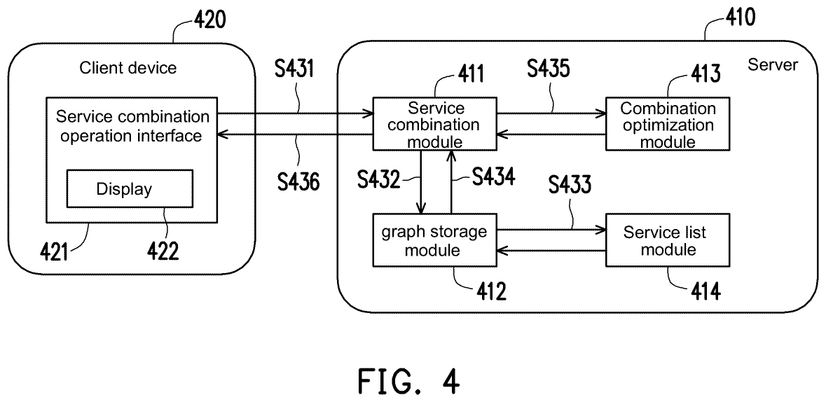

FIG. 4 is a schematic diagram of a client device and a server according to an embodiment of the disclosure. The service combination device 100 includes a server 410 and a client device 420. The client device 420 may be a personal computer or a tablet. A service combination operation interface 421 is used for receiving data and setting values input by the user. In an embodiment, the service combination operation interface 421 includes a display 422 for displaying setting fields and output data (for example, the optimized service data combination 102). Referring to FIG. 1, FIG. 3 and FIG. 4, the service combination device 100 may execute following steps S431-S436. In step S431, the user operates the service combination operation interface 421 through the client device 420 to input the service to be called or the description of the target data to be obtained (i.e., the initial data 101), and the service combination operation interface 421 inputs the initial data 101 to a service combination module 411.

In an embodiment, the initial data 101 is a target data description, and the target data description relates to result data obtained after calling the API. The initial data 101 further includes a raw data description, and the raw data description is the initial data input into the API. It should be noted that the service combination module 411 splits the initial data 101 into a plurality of target data. The initial data includes a plurality of target service data, and the target service data is calling data related to the API, and the initial data 101 further includes the raw data description. The raw data description is a data description that may be obtained from the current data source and context (i.e., previous steps and subsequent steps).

In step S432, the processor 110 executes the service combination module 411 to input the initial data 101 into the graph storage module 412 through the service combination module 411. In this way, the service combination module 411 searches the data graph through the graph storage module 412 to obtain a plurality of services corresponding to the initial data 101. In other words, the graph storage module 412 searches the data graph according to the plurality of target data (i.e., a splitting result of the initial data 101), and then obtains a plurality of service data combinations. Specifically, the data graph includes a plurality of services (i.e., service data calling corresponding services), input data and output data of each service, and mapping data of each data (i.e., mapping data of different format types). In this way, the processor 110 may obtain the plurality of service data combinations corresponding to the initial data 101 through the data graph stored in the graph storage module 412. For example, the initial data 101 is service data A and current data D. In the embodiment, according to the data graph, it may be obtained that the service data A needs to be executed through the current data D, the user needs to execute service data B and service data C in sequence, so as to execute the service data A from the current data D. Therefore, the service data combination is the combination of the service data B and the service data C in sequence. It should be noted that each service data combination includes a plurality of service data and sequence parameters (i.e., a sequence and an execution sequence of a plurality of services).

In step S433, when the service (i.e., service data) corresponding to the initial data 101 does not exist in the data graph, the processor 110 queries a service list, and constructs a queried service description in the data graph. Specifically, the service combination device 100 further includes a service list module 414. The service list module 414 stores a callable service list. The callable service list includes a plurality of data descriptions corresponding to a plurality of service data. In other words, when the data graph does not have the corresponding plurality of target data, the processor 110 executes the service list module 414 to obtain the plurality of data descriptions respectively corresponding to the plurality of target data according to the callable service list. Then, the service list module 414 creates the plurality of service data into the data graph according to the corresponding plurality of data descriptions.

In an embodiment, the service list is established by registering metadata information into the service list module 414. Moreover, the service list module 414 creates requests and responses in the service list according to the metadata information. The processor 110 execute the service list module 414 to query the data description of each of services in the service list. The data description is the metadata information when establishing the service list. In one embodiment, the service list module 414 queries the metadata information based on the service interface name (i.e., service_name), or queries the metadata information of all of service interfaces. The service list module 414 query the metadata information of the data name, which is specified, in the service list based on the data name (i.e., data_name).

In other words, the service list module 41 may search for corresponding data descriptions from the callable service list according to the target data, and then create the corresponding service data in the data graph according to the data descriptions. The processor 110 establishes a data graph through data structures. The data structures are actions, parameters and return values of calling service types in the metadata. The data structures at least include the name and description of the data object or data field, the data type of the data field, such as integer, date, string, and business primary key of the data object. For instance, the business primary key of the Sales Order object is Sales Order number. Moreover, the processor 110 establishes relationships between multiple actions and multiple data in the data graph according to multiple rules or algorithms. In other words, the rules in the data graph include mapping relationships between the multiple data and the multiple actions. The rules are matching based on object and field names, establishing mappings between data based on semantics, and based on Natural Language Processing (NLP) through relationships between data to construct multiple data objects and mapping relationships between multiple data fields.

In step S434, the graph storage module 412 returns the optional multiple service data combinations (i.e., paths including multiple services) to the service combination module 411. In step S435, the service combination module inputs the plurality of service data (i.e., service data related to calling services) into a combination optimization module 413, so as to find a most suitable service data combination (i.e., service path) through an optimization strategy. Specifically, the storage device 120 stores an optimization setting. According to the optimization setting, the combination optimization module 413 selects an optimized service data combination corresponding to the optimization setting from multiple service data combinations. For example, the optimization setting is the setting of the least service data (API service to be called). The combination optimization module 413 selects the service data combination with the least service data from the multiple service data combinations, and uses the service data combination as the optimized service data combination 102.

In step S436, the processor 110 executes the combination optimization module 413 and the service combination module 411 to output the service data combination that may achieve the target (i.e., API services complied with the initial data 101) to the service combination operation interface 422 of the client device 420. Specifically, the service combination module 411 outputs the optimized service data combination 102 to the service combination operation interface 421, and displays the optimized service data combination 102 on the display 422. It should be noted that the optimized service data combination output by the service combination device 100 is at least one of the target data descriptions corresponding to the initial data and the target service data.

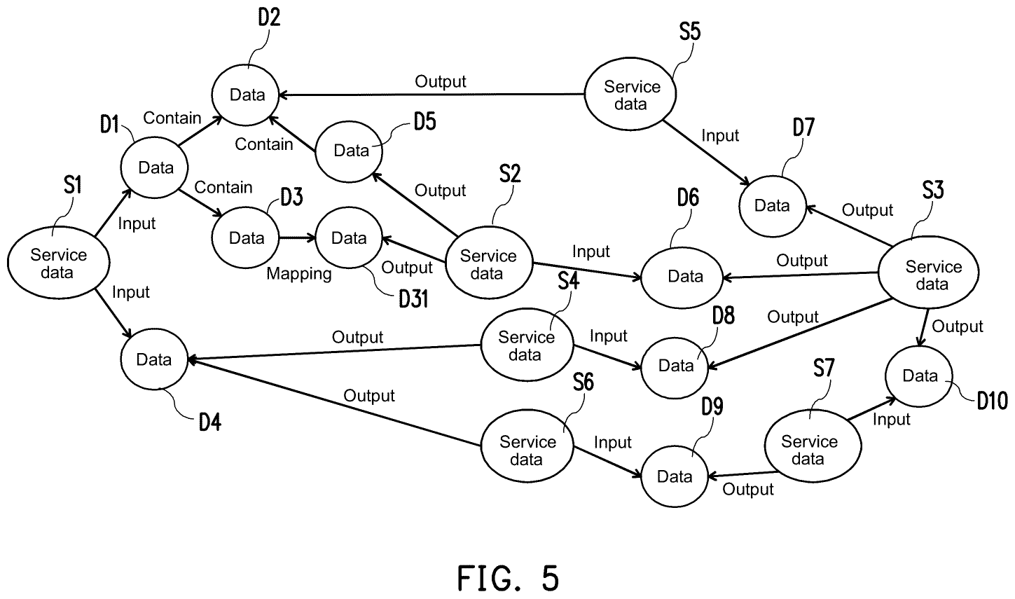

FIG. 5 is a schematic diagram of a data graph according to an exemplary embodiment of the disclosure. Referring to FIG. 1 to FIG. 5, in an embodiment, a data graph corresponding to the initial data 101 includes service data S1, service data S2, service data S3, service data S4, service data S5, service data S6, and service data S7. For example, the service data S1 is a service of calculating project cost information, the service data S2 is a service of obtaining project purchase information, the service data S3 is a service of obtaining project working hours, the service data S4 is a service of obtaining labor cost, the service data S5 is a service of obtaining project inventory information, the service data S6 is a service of calculating employee working hours, and the service data S7 is a service of calculating employee total working hours. In the embodiment, the optimized service data combination 102 output by the service combination device 100 is the service data S2, the service data S3 and the service data S4. In the exemplary embodiment, the plurality of service data combinations include a service combination 1: the service data S2, the service data S3 and the service data S4, and a service combination 2: the service data S2, the service data S3, the service data S6 and the service data S7. Since the service combination 1 has fewer paths than the service combination 2.

Therefore, the combination optimization module 413 selects the service combination 1 from multiple service data combinations to serve as the optimized service data combination 102 according to the optimization setting (for example, optimized path, the shortest path). In the embodiment, data D1 to data D10 are input data and output data related to each of the service data S1-S7, such as employee number, working hours, project cost, hourly salary, purchase amount, labor cost information, project purchase information, purchase amount, etc. It should be noted that the data graph includes a mapping relationship of multiple data. For example, the mapping of data D3 is data D31, and the mapping relationship may be format conversion and conversion between different types of data. In this way, the compatibility of the service combination device 100 for different types of data may be greatly improved.

Therefore, the service combination device 100 and the service combination method of the disclosure may search the data graph according to the initial data 101, and then obtain the optimized service data combination 102 according to the optimization setting, so as to output to the service combination operation interface. Moreover, the service combination device 100 displays the optimized service data combination 102 on the display 422, so that the user may confirm the content of the optimized service data combination 102, so as to output the service data combination that conforms to the initial data 101 (i.e., the data for calling multiple API services and sequence parameters), so that the user may achieve rapid combination through the service combination device 100 and solve the problem of data adaptation caused by different data types.

It will be apparent to those skilled in the art that various modifications and variations can be made to the disclosed embodiments without departing from the scope or spirit of the disclosure. In view of the foregoing, it is intended that the disclosure covers modifications and variations provided they fall within the scope of the following claims and their equivalents.

What is claimed is:

1. A service combination device, comprising:
a storage device, configured to store a service combination module, a graph storage module, and a combination optimization module
a processor, coupled to the storage device and configured to receive initial data,
wherein the processor executes the service combination module to generate a plurality of target data according to the initial data,
wherein the processor executes the graph storage module to search a data graph according to the plurality of target data, so as to obtain a plurality of service data combinations,
wherein the processor executes the combination optimization module to filter out an optimized service data combination from the plurality of service data combinations.

2. The service combination device according to claim 1, wherein the graph storage module is a database, and the plurality of service data combinations comprise service directionality parameters, wherein the data graph comprises a plurality of service data, a plurality of input data, and a plurality of output data,
wherein the data graph further comprises a connection relationship and a mapping relationship of the plurality of service data, the plurality of input data, and the plurality of output data.

3. The service combination device according to claim 1, further comprising a service combination operation interface for receiving the initial data,
wherein the service combination module outputs the optimized service data combination to the service combination operation interface, and displays the optimized service data combination on a display,
wherein the optimized service data combination is at least one of target data description and target service data.

4. The service combination device according to claim 1, wherein the service combination module splits the initial data into the plurality of target data.

5. The service combination device according to claim 4, wherein the initial data is target service data, and the target service data relates to calling data of an application programming interface, and the initial data further comprises a raw data description.

6. The service combination device according to claim 4, wherein the initial data is a target data description, the target data description is related to result data obtained after calling the application programming interface, and the initial data further comprises a raw data description, and the raw data description is initial data input into the application programming interface.

7. The service combination device according to claim 1, wherein the storage device stores an optimization setting, wherein according to the optimization setting, the combination optimization module selects the optimized service data combination corresponding to the optimization setting from the plurality of service data combinations.

8. The service combination device according to claim 7, wherein the optimization setting is a setting of the least service data, wherein the combination optimization module selects the service data combination with the least service data from the plurality of service data combinations, and takes the service data combination as the optimized service data combination.

9. The service combination device according to claim 1, further comprising a service list module, wherein the service list module stores a callable service list, and each service data combination in the plurality of service data combinations comprises a plurality of service data and sequence parameters.

10. The service combination device according to claim 9, wherein the callable service list comprises a plurality of data descriptions corresponding to the plurality of service data, wherein when the data graph does not have the corresponding plurality of target data, the processor executes the service list module to obtain a plurality of data descriptions respectively corresponding to the plurality of target data according to the callable service list,
wherein the service list module creates the plurality of service data into the data graph according to the corresponding plurality of data descriptions,
wherein the graph storage module searches the data graph according to the plurality of target data, and then obtains the plurality of service data combinations.

11. A service combination method, comprising:
receiving initial data by a processor;
executing a service combination module by the processor to generate a plurality of target data according to the initial data;
executing a graph storage module by the processor to search for a data graph according to the plurality of target data, so as to obtain a plurality of service data combinations; and
executing a combination optimization module by the processor to filter out an optimized service data combination from the plurality of service data combinations.

12. The service combination method according to claim 11, wherein the graph storage module is a database, and the plurality of service data combinations comprise service directionality parameters, wherein the data graph comprises a plurality of service data, a plurality of input data, and a plurality of output data,
wherein the data graph further comprises a connection relationship and a mapping relationship of the plurality of service data, the plurality of input data, and the plurality of output data.

13. The service combination method according to claim 11, further comprising:
outputting the optimized service data combination to a service combination operation interface by the service combination module, and displaying the optimized service data combination on a display,
wherein the optimized service data combination is at least one of target data description and target service data.

14. The service combination method according to claim 11, wherein the step of generating the plurality of target data according to the initial data comprises:
splitting the initial data into the plurality of target data by the service combination module.

15. The service combination method according to claim 14, wherein the initial data is target service data, the target service data relates to calling data of an application programming interface, and the initial data further comprises a raw data description.

16. The service combination method according to claim 14, wherein the initial data is a target data description, the target data description is related to result data obtained after calling the application programming interface, and the initial data further comprises a raw data description, and the raw data description is initial data input into the application programming interface.

17. The service combination method according to claim 11, wherein the step of filtering out the optimized service data combination from the plurality of service data combinations comprises:
selecting the optimized service data combination corresponding to the optimization setting from the plurality of service data combinations by the combination optimization module according to the optimization setting.

18. The service combination method according to claim 17, wherein the optimization setting is a setting of the least service data, wherein the combination optimization module selects the service data combination with the least service data from the plurality of service data combinations, and takes the service data combination as the optimized service data combination.

19. The service combination method according to claim 11, wherein a service list module stores a callable service list, and each service data combination in the plurality of service data combinations comprises a plurality of service data and sequence parameters.

20. The service combination method according to claim 19, wherein the callable service list comprises a plurality of data descriptions corresponding to the plurality of service data, wherein the step of searching for the data graph according to the plurality of target data, so as to obtain the plurality of service data combinations comprises:
when the data graph does not have the corresponding plurality of target data, executing the service list module by the processor to obtain a plurality of data descriptions respectively corresponding to the plurality of target data according to the callable service list;
executing the service list module to create the plurality of service data into the data graph according to the corresponding plurality of data descriptions; and
executing the graph storage module to search the data graph according to the plurality of target data, so as to obtain the plurality of service data combinations.
